(19) United States
(12) Patent Application Publication
(10) Pub. No.: US 2024/0391427 A1
(43) Pub. Date: Nov. 28, 2024

(54) SYSTEM FOR SENSOR CLEANING WITH HEATED FLUID

(71) Applicant: Ford Global Technologies, LLC, Dearborn, MI (US)

(72) Inventors: Venkatesh Krishnan, Canton, MI (US); Segundo Baldovino, Novi, MI (US); Michael Robertson, JR., Garden City, MI (US)

(73) Assignee: Ford Global Technologies, LLC, Dearborn, MI (US)

(21) Appl. No.: 18/323,763

(22) Filed: May 25, 2023

(51) Int. Cl. B60S 1/48; B60S 1/56

(52) U.S. Cl. CPC B60S 1/488; B60S 1/56

(57) ABSTRACT

A system for maintaining heated fluid for sensor cleaning includes a reservoir, a heat exchanger, and a manifold fluidly coupled to the heat exchanger and to the reservoir. The manifold additionally includes a set of pumps positioned to distribute fluid to a set of sensors. A controller is programmed to actuate flow of cleaning fluid from the manifold to the heat exchanger responsive to an output signal from the temperature sensor.

### BACKGROUND

Vehicles typically include a variety of sensors. Some sensors detect internal states of the vehicle, for example, wheel speed, wheel orientation, and engine and transmission variables. Some sensors detect the position or orientation of the vehicle, for example, sensors of a satellite positioning system (e.g., GPS); accelerometers such as piezo-electric or microelectromechanical systems (MEMS); gyroscopes such as rate, ring laser, or fiber-optic gyroscopes; inertial measurements units (IMU); and magnetometers. Some sensors detect the external world, such as, radar sensors, scanning laser range finders, light detection and ranging (lidar) devices, and imaging sensors such as cameras. When sensor lenses, protective coverings, and the like, become obscured by dust, dirt, snow/ice, etc., sensor operation can be degraded.

### BRIEF DESCRIPTION OF THE DRAWINGS

FIG. 1 is a perspective view of a vehicle having a system for maintaining heated fluid in a sensor cleaning assembly.

FIG. 2 is a diagram showing the system for maintaining heated fluid in the sensor cleaning assembly.

FIG. 3 is a flowchart of an example process for operating the system for maintaining heated fluid in the sensor cleaning assembly.

### DETAILED DESCRIPTION

A system for maintaining heated fluid for sensor cleaning may include a heat exchanger having an inlet port and an outlet port, a reservoir having an inlet port and an outlet port and a conduit directly fluidly coupling the outlet port of the heat exchanger to the inlet port of the reservoir. The system can additionally include a manifold having an inlet port and a plurality of outlet ports, the inlet port fluidly coupled to the outlet port of the reservoir, the plurality of outlet ports including a first outlet port and a plurality of second outlet ports, the first outlet port being fluidly coupled to the inlet port of the heat exchanger, the system can additionally include a set of pumps at the second outlet ports of the manifold, the pumps being positioned to distribute fluid from the second outlet ports to a set of sensors. The system can additionally include a temperature sensor within the reservoir, which is communicatively coupled to a controller, the controller programmed to actuate flow of cleaning fluid from the manifold to the heat exchanger responsive to an output signal from the temperature sensor.

In an example, the controller may be programmed to actuate flow of the cleaning fluid through the heat exchanger responsive to the temperature sensor indicating that the temperature of the cleaning fluid is below a first threshold value.

In an example, the temperature sensor may be positioned at a bottom portion of the reservoir.

In an example, the temperature sensor may be positioned within the reservoir proximate to the outlet port of the reservoir.

In an example, the system may be positioned in a vehicle and the heat exchanger may include a fluid conduit integrated into a radiator structure of the vehicle.

In an example, the system may be positioned in a vehicle, in which the heat exchanger comprises a first fluid conduit integrated into a radiator structure of the vehicle, and in which the first fluid conduit is proximate with a second fluid conduit of the radiator structure that is positioned to carry coolant from a propulsion component of the vehicle.

In an example, the controller may be additionally programmed to deactivate fluid flow from the manifold to the heat exchanger responsive to the output signal from the temperature sensor indicating that the temperature of the cleaning fluid is above a second threshold value.

In an example, the system may be positioned in a vehicle, in which the number of pumps of the set of pumps of the manifold corresponds to the number of sensors of the set of sensors.

In an example, the manifold may additionally include a check valve at each pump of the set of pumps.

In an example, the controller may additionally be programmed to actuate cleaning fluid flow from the manifold to the heat exchanger responsive to the output signal from the temperature sensor indicating a temperature that is between a first threshold value and a second threshold value.

In an example, the controller may additionally be programmed to maintain the temperature of the cleaning fluid between a first threshold and a second threshold at all times while a vehicle including the system is being operated.

In an example, the controller may additionally be programmed to periodically initiate fluid flow from the reservoir to a sensor of the set of sensors based on an air temperature of an environment external to the system.

In an example, the controller may additionally be programmed to periodically initiate fluid flow to a sensor of the set of sensors at an increased frequency based on a decreased air temperature of an environment external to the system.

In an example, the controller may additionally be programmed to actuate cleaning fluid flow from the manifold to the heat exchanger responsive to the output signal from the temperature sensor indicating a temperature that is between a first threshold value and a second threshold value, the first threshold value and the second threshold value being selected to exclude degradation of a hydrophobic coating of a sensor surface.

In an example, the system may further include a circulation pump positioned at the inlet port of the manifold.

In an example, the system may further include a circulation pump positioned at the inlet port of the manifold, in which the circulation pump circulates the cleaning fluid through the heat exchanger and through the reservoir.

In an example, the system may further include a circulation pump positioned at the inlet port of the manifold, the circulation pump configured to circulate the cleaning fluid through the heat exchanger and through the reservoir until the temperature sensor outputs a signal indicating that the temperature of the cleaning fluid has reached or exceeded a first threshold value.

In an example, the system may further include a circulation pump, positioned at the inlet port of the manifold at a first end portion of the manifold.

In an example, the system may further include a circulation pump, positioned at the inlet port of the manifold at a first end portion of the manifold, wherein the first outlet port of the manifold is positioned at a second end portion of the manifold that is opposite the first end portion.

In an example, the inlet port to the reservoir may be positioned at a location opposite the outlet port of the reservoir.

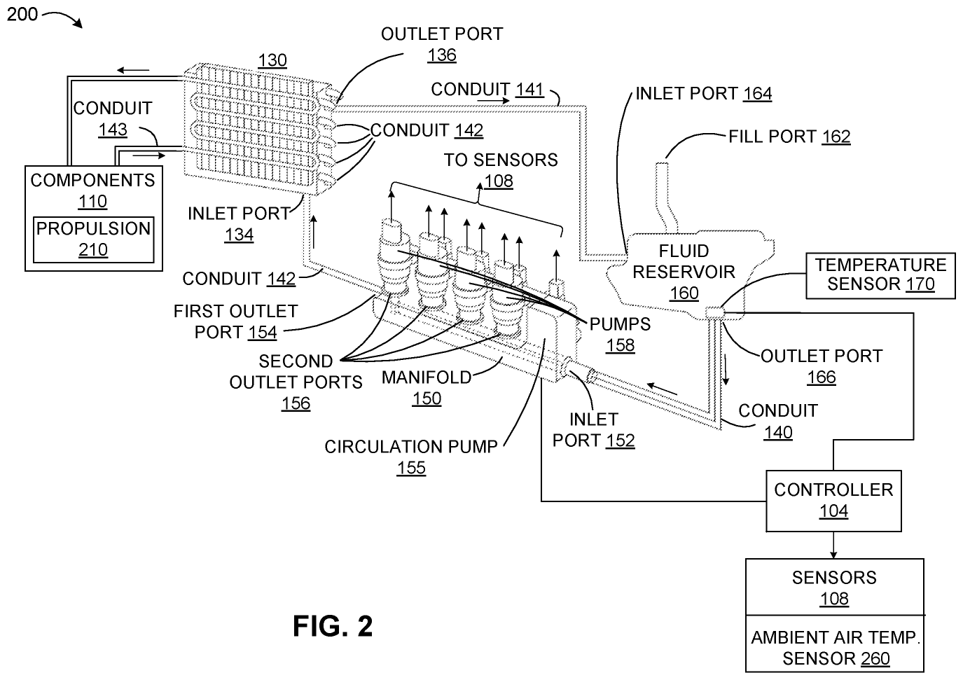

With reference to the Figures, wherein like numerals indicate like parts throughout the several views, system 100 includes sensor cleaning assembly 105 of vehicle 102 includes fluid reservoir 160, manifold 150, and heat exchanger 130, outlet port 136 of which is directly fluidly coupled to an inlet port of fluid reservoir 160. For the purposes of this disclosure, an “outlet port” is defined as a component of a structure that permits a fluid to be released from the structure. For the purposes of this disclosure, “directly fluidly coupled” is defined as a fluid connection without intervening components for pumping or storing the fluid. Direct coupling between heat exchanger 130 and fluid reservoir 160 can minimize head loss, thereby maximizing fluid flow between the heat exchanger and the fluid reservoir. Manifold 150 includes a circulation pump 155 (FIG. 2), which is operable to draw fluid from outlet port 166 (FIG. 2) of fluid reservoir 160 and propel the fluid from fluid reservoir 160 through a portion of the manifold to first outlet port 154 (FIG. 2). Fluid from first outlet port 154 may be delivered to an inlet port of heat exchanger 130. Heat exchanger 130 may include fluid conduit 142 (of FIG. 2) that is integrated with a radiator or other heat-transferring structure of vehicle 102.

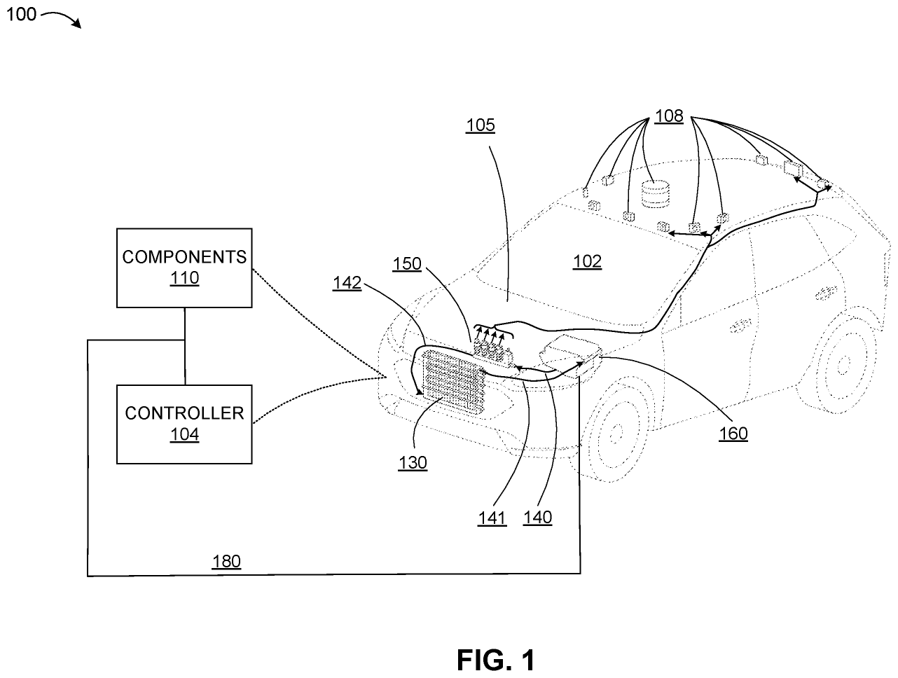

As will be described in greater detail herein, in the course of operating vehicle 102. sensors of sensor set 108 of the vehicle may become obscured by materials encountered in the driving environment of vehicle 102. Such materials may include dust, dirt (e.g., mud), snow, ice, or other obscuring agents. Accordingly, manifold 150 includes second outlet ports, which may be utilized for selectively distributing fluid from fluid reservoir 160 to different nozzles for cleaning lenses, covers, or other surfaces of sensors of sensor set 108 of vehicle 102. In an example, fluid reservoir 160 is utilized to store a cleaning fluid, which, in the context of this disclosure means any liquid stored in fluid reservoir 160 for cleaning lenses, covers, and/or other surface of a sensor. Accordingly, a cleaning fluid may include fluids such as water, ethanol, isopropanolamine, ammonium hydroxide, sulfonate, sodium xylene, or any other fluid, which may operate to assist in removal of an obscurant from the lenses, covers, or other surfaces of sensors at 108. In the example of FIG. 1, manifold 150 includes 8 second outlet ports, wherein a pump coupled to each second outlet port. Manifold 150 may thus selectively pump cleaning fluid to all of sensors of sensor set 108 or any subset of sensor set 108 (e.g., 1 sensor, 2 sensors, 3 sensors, etc.).

Responsive to vehicle 102 being operated in a driving environment that includes ice, snow, freezing rain, or during other conditions that could bring about an accumulation of ice on the lenses, covers, or other surfaces of sensor set 108, sensor cleaning assembly 105 may selectively distribute heated fluid, e.g., cleaning fluid, to the lenses, covers, or other surfaces of sensor set 108. Accordingly, the heated cleaning fluid may operate to liquefy accumulated ice, thereby reducing or eliminating ice that may have accumulated on the surfaces of sensor set 108. In the example of FIG. 1, sensor cleaning assembly 105 may include a temperature sensor, which may be located proximate to outlet port 166 (FIG. 2) of fluid reservoir 160, may output a signal for use by controller 104. In response to the temperature sensor indicating a temperature of less than a first threshold, controller 104 may actuate a circulation pump of manifold 150 positioned at inlet port 152, which operates to pump cleaning fluid from outlet port 166 of fluid reservoir 160 through a length of manifold 150, for delivery to an inlet port of heat exchanger 130. Heated fluid may travel through heat exchanger 130 for output at outlet port 136 (FIG. 2) of heat exchanger 130. Heated fluid may then be delivered to fluid reservoir 160, so as to permit mixing of heated fluid with the fluid stored within fluid reservoir 160. A pump of manifold 150 may continue to pump fluid through heat exchanger 130 for delivery to fluid reservoir 160 until the temperature sensor within reservoir 160 outputs a signal for receipt by controller 104, indicating a temperature that is greater than a second threshold value. Responsive to the temperature sensor measuring a temperature of the fluid within reservoir 160 that has reached a second threshold, controller 104 may deactivate the pump of manifold 150.

With reference to FIG. 1, vehicle 102 may be any passenger or commercial automobile such as a car, a truck, a sport utility vehicle, a crossover, a van, a minivan, a taxi, a bus, etc. Sensor set 108 of vehicle 102 can include any sensor for detecting the attributes of an environment external to vehicle 102, such as objects and/or characteristics of surroundings of vehicle 102. Accordingly, sensor set 108 may operate to detect other vehicles, road lane markings, traffic lights and/or signs, pedestrians, etc. For example, sensor set 108 may include radar sensors, ultrasonic sensors, scanning laser range finders, light detection and ranging (lidar) devices, and image processing sensors such as cameras.

Sensor cleaning assembly 105 includes fluid reservoir 160, manifold 150, and heat exchanger 130. Fluid reservoir 160, manifold 150, and heat exchanger 130 may be spaced apart from each other in vehicle 102. For example, fluid reservoir 160, manifold 150, and heat exchanger 130 may be located at different positions in the front end of vehicle 102, thereby keeping fluid conduits 140, 141, and 142 (FIG. 2) between these components short compared with locating one or more of fluid reservoir 160 and manifold 150 at a rear portion of vehicle 102, while heat exchanger 130 is positioned at a front portion of vehicle 102. In an example, manifold 150 may be positioned at a location of vehicle 102 that reduces the aggregated length of fluid conduits between manifold 150 sensor set 108.

Fluid conduits for delivering fluid from manifold 150 to sensors of sensor set 108 may be routed from the manifold along any structural component of vehicle 102, such as horizontally oriented or vertically oriented support structures. Fluid conduits may be substantially rigid or may be flexible so as to permit the fluid conduits to be routed along or through a variety of structural components of vehicle 102. Fluid conduits may be bundled, for example, so that each output of manifold 150 conveys fluid to a separate sensor of sensor set 108.

FIG. 2 is a diagram showing a system 200 for maintaining heated fluid in a sensor cleaning assembly. In reference to FIG. 2, sensor cleaning assembly 105 includes fluid reservoir 160, manifold 150, and heat exchanger 130. Fluid reservoir 160 includes inlet port 164 and outlet port 166, which may be positioned at a location opposite to inlet port 164. Accordingly, responsive to fluid reservoir 160 being filled with cleaning fluid, heated cleaning fluid may be permitted to enter fluid reservoir 160 and to mix with fluid within fluid reservoir 160 before being dispensed to manifold 150 via outlet port 166 and fluid conduit 140. Fluid reservoir 160 may include temperature sensor 170, which may be positioned at a location proximate to outlet port 166, e.g., at a bottom portion of fluid reservoir 160. Accordingly, temperature sensor 170 may output a temperature measurement that reflects an actual temperature of fluid being dispensed to manifold 150. Fluid reservoir 160 may include fill port 162, so as to permit refilling of fluid.

Temperature sensor 170 may output a signal to be received by controller 104. In an example, outputs of temperature sensor 170 may be transmitted to controller 104 utilizing communications network 180 within vehicle 102. Temperature sensor 170 may be any type of temperature sensing device, such as a thermally sensitive resistor, a thermocouple, a resistance temperature detector, an infrared sensor, etc.

Outlet port 166 of fluid reservoir 160 may be fluidly coupled to inlet port 152 of manifold 150, thus permitting fluid to flow from reservoir 160 to manifold 150. Manifold 150 may actuate one or more of pumps 158 at second outlet ports 156 responsive to receiving a signal from controller 104 indicating that one or more of sensors of sensor set 108 may be exhibiting decreased performance due to an obscurant on the lens, cover, or other surface of the one or more sensors. In an example, the number of pumps 158 corresponds to the number of sensors of sensor set 108. In response to receiving a signal indicating degraded performance of one of sensor set 108, controller 104 may output a signal to manifold 150 to actuate one of pumps 158 to begin delivering cleaning fluid to the degraded sensor. The actuated pump may continue to deliver cleaning fluid to the affected sensor for a specified interval, such as 1 second, 2 seconds, 5 seconds, etc. A specified interval may be determined based on a level of degradation in sensor performance. For example, in response to a nominal degradation in performance of one of sensor set 108, which may indicate a relatively small patch of obscurant on a sensor surface, controller 104 may actuate a pump of pumps 158 to deliver cleaning fluid to the affected sensor over a relatively small interval, e.g., 1 second, 2 seconds, etc. In another example, in response to more significant degradation in the performance of a sensor of sensor set 108, which may indicate a larger mass of obscurant on a sensor surface, controller 104 may actuate a pump of pumps 158 to deliver cleaning fluid to the affected sensor over a longer interval, e.g., 3 seconds, 5 seconds, etc. In an example, in response to an affected sensor of sensor set 108 continuing to exhibit degraded performance, controller 104 may repeatedly actuate a pump of pumps 158 until controller 104 determines that the affected sensor is not obscured, but, rather, is experiencing a degradation that may not be related to an obscurant on the lens, cover, or other surface of the sensor.

In an example, in response to ambient air temperature sensor 260 measuring an outside air temperature that is, for example, below freezing (e.g., approximately 0° C.), controller 104 may intermittently actuate pumps 158 coupled to some or all of second outlet ports 156. Occasional or periodic actuation of pumps 158 coupled to second outlet ports 156 may operate to minimize the possibility of formation of ice within conduits that fluidly couple second outlet ports 156 to lenses, covers, or other surfaces of sensor set 108. Thus, in response to controller 104 detecting degraded performance of a sensor(s) of sensor set 108 at a future time, cleaning fluid can be distributed to the affected sensor(s). In an example, controller 104 may periodically actuate pumps 158 at an increased frequency based on a decreased air temperature of environment external to the vehicle 102. Thus, for example, responsive to measurement of an outside air temperature of −5° C., controller 104 may actuate fluid flow at 5-minute intervals. Responsive to measurement of an outside air temperature of −10° C., controller 104 may actuate fluid flow at 2-minute intervals.

In an example, fluid within fluid reservoir 160 may be maintained within a range of temperatures that are high enough to liquefy ice that may form on a surface of the sensors of sensor set 108 but low enough so as to preclude degradation of any specialized coatings, such as hydrophobic coatings, which may be present on a surface of a sensor of sensor set 108. In one example, controller 104 operates to maintain a temperature of fluid within fluid reservoir 160 between a first threshold temperature of 37° C. and a second threshold temperature of 44° C. However, in an example in which specialized coatings, e.g., hydrophobic coatings, are not utilized at surfaces of sensor set 108, fluid within fluid reservoir 160 may be maintained at a different range, such as between 65° C. and 70° C. In an example, controller 104 operates to maintain a temperature of fluid within fluid reservoir 160 at substantially all times while vehicle 102 is operating.

Pumps 158 coupled to second outlet ports 156 may each include a one-way valve, e.g., a check valve, so as to preclude pumped fluid from returning to manifold 150. Pumps 158 may operate to pump fluid at a pressure sufficient to transfer fluid from a nozzle to surfaces of sensor set 108.

In the example of FIG. 2, first outlet port 154 of manifold 150 is fluidly coupled to inlet port 134 of heat exchanger 130. In an example, heat exchanger 130 includes a continuation of fluid conduit 142 having multiple, e.g., between 2 and 10, bends, e.g., 45-degree bends, 90-degree bends, 180-degree bends, etc., which is integrated into and/or thermally coupled to a radiator structure of vehicle 102. The radiator structure may additionally include fluid conduit 143, which receives coolant from various heat-generating components of vehicle 102, such as propulsion components 210, e.g., internal combustion engines, electric motors, electric vehicle batteries etc. Accordingly, the structure of the radiator of vehicle 102 may operate to transfer heat from fluid conduit 143 conveying coolant from heat-generating components of the vehicle to the fluid output from manifold 150. Accordingly, as fluid from inlet port 134 traverses through the radiator structure, e.g., from inlet port 134 to outlet port 136, the cleaning fluid receives heat transferred from components 110 via the radiator structure. Heated fluid from outlet port 136 is then output, via fluid conduit 141, to inlet port 164 of fluid reservoir 160.

Controller 104 may include a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. Controller 104 can thus include a processor, a memory, etc. The memory of controller 104 can include media for storing instructions executable by the processor as well as for electronically storing data and/or databases, and/or controller 104 can include structures such as the foregoing by which programming is provided. Controller 104 can be multiple computers coupled together.

Controller 104 may transmit and receive data through communications network 180 such as a controller area network (CAN) bus, Ethernet, WiFi, Local Interconnect Network (LIN), onboard diagnostics connector (OBD-II), and/or by any other wired or wireless communications network. Controller 104 may be communicatively coupled to manifold 150, sensor set 108, temperature sensor 170, and ambient air temperature sensor 260. Controller 104 may be programmed to actuate circulation pump 155 of manifold 150 and pumps 158 positioned at second outlet ports 156 to pump fluid from the manifold to nozzles proximate to the sensors of sensor set 108 in response to detecting that a lens, cover, or other surface of one or more of the sensors is exhibiting degraded performance. In an example, data indicating a degradation in sensor performance degradation may originate from a sensor of sensor set 108. Controller 104 may selectively actuate any one or more of pumps 158 at second outlet ports 156 to pump fluid to nozzles aimed at surfaces of sensors of sensors at 108. In an example, controller 104 may determine, e.g., in accordance with known image-analysis techniques, that a set of pixels in image data received from one of sensors at 108 is unchanging over time compared to the other of the pixels in the image data, suggesting that a portion of the field of view of a sensor of sensors at 108 has been obscured.

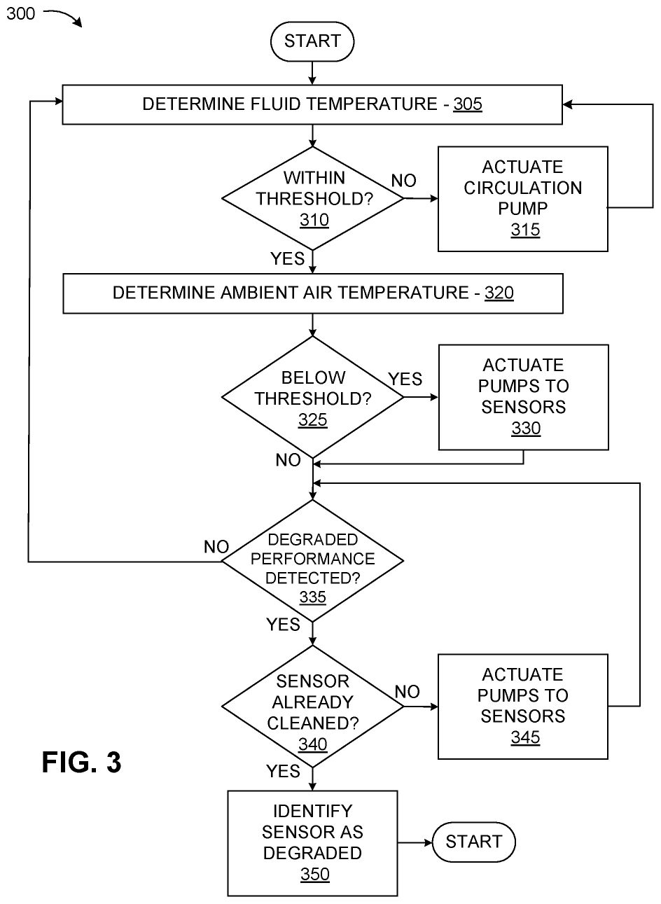

FIG. 3 is a flowchart of an example process 300 for operating a system for maintaining heated fluid in a sensor cleaning assembly. The process of FIG. 3 can be performed by sensor cleaning assembly 105 to maintain fluid in fluid reservoir 160 at a temperature between first and second thresholds via actuation of circulation pump 155. In response to an output signal from temperature sensor 170 indicating that the fluid within fluid reservoir 160 has fallen below a first temperature threshold, controller 104 may actuate circulation pump 155 so as to circulate fluid from fluid reservoir 160, through manifold 150, and through heat exchanger 130. Heated fluid may then be output from heat exchanger 130 to inlet port 164 of fluid reservoir 160, which permits the heated fluid to mix with existing fluid in the reservoir. Such circulation may continue until temperature sensor 170 indicates a fluid temperature that has reached a second threshold. In response to the fluid within fluid reservoir 160 reaching the second threshold temperature, programming of controller 104 may deactivate circulation pump 155. Further, responsive to ambient air temperature sensor 260 indicating a temperature of less than a predetermined threshold, e.g., 0° C., −5° C., −10° C., etc., controller 104 may intermittently actuate some or all of pumps 158 positioned at second outlet ports 156 of manifold 150. Accordingly, heated fluid, e.g., heated cleaning fluid, can be maintained in the fluid conduits for cleaning individual sensors of sensor set 108, thereby precluding or minimizing the possibility of formation of ice within the fluid conduits between manifold 150 and the sensors of sensor set 108.

Process 300 begins in block 305, in which controller 104 determines a temperature of a fluid, e.g., a cleaning fluid, within fluid reservoir 160. In an example, a temperature of the fluid within fluid reservoir 160 is indicated by temperature sensor 170. In an example, temperature sensor 170 transmits a binary signal to indicate whether the temperature of the fluid within fluid reservoir 160 is below a threshold. Temperature sensor 170 may transmit temperature data, e.g., actual temperature, binary signal, etc., directly to controller 104 or may transmit temperature data to communications network 180 of vehicle 102.

Process 300 continues at block 310, in which controller 104 receives or obtains output data from temperature sensor 170 and determines whether the output data, e.g., actual temperature, binary signal, etc., indicates a fluid temperature that is above or below a threshold value. In response to the fluid temperature being outside, e.g., below, a first threshold value, block 315 may be performed, in which controller 104 actuates circulation pump 155. Actuation of circulation pump 155 initiates fluid flow drawn from fluid reservoir 160, through manifold 150, to an inlet port of heat exchanger 130. Controller 104 may be programmed to continuously operate circulation pump 155 until output data from temperature sensor 170 indicates that the temperature of the fluid within fluid reservoir 160 has attained a second threshold temperature, which may be greater than the first threshold temperature.

Process 300 continues at block 320, in which controller 104 determines an ambient air temperature via ambient air temperature sensor 260. Ambient air temperature sensor 260 may output data directly to controller 104 or may provide output data to communications network 180.

Process 300 continues at block 325, in which controller 104 compares output data from ambient air temperature sensor 260 to a temperature threshold. In response to output data from ambient air temperature sensor 260 indicating a temperature below the threshold, e.g., 0° C., −5° C., −10° C., etc., block 330 may be performed, in which controller 104 actuates pumps 158 coupled to second outlet ports 156. Controller 104 may actuate pumps 158 for a brief interval, e.g., 1 second, 2 seconds, 3 seconds, etc., so as to preclude the formation of ice, which may operate to block fluid flow in the event of accumulation of ice on a lens, cover, or other surface of a sensor of sensor set 108. In response to receiving output data from ambient air temperature sensor 260 indicating an ambient temperature above the threshold, no fluid is pumped from manifold 150 to sensor set 108.

Process 300 continues at block 335, in which controller 104 detects that one or more sensors of sensor set 108 is exhibiting degraded performance. In response to no degradations in performance being detected by controller 104, process 300 returns to block 305.

Process 300 continues at block 340, in which controller 104 determines whether the sensor exhibiting degraded performance has already been cleaned within a recent period of time, e.g., the past 1 minute, the past 2 minutes, etc. In response to controller 104 determining that a degraded sensor has not been cleaned within the recent period of time, block 345 can be performed, in which controller 104 actuates pumping of fluid to a nozzle proximate to the degraded sensor.

In response to controller 104 determining that the degraded sensor of sensor set 108 has already been cleaned, i.e., at block 340, process 300 continues at block 350, in which controller 104 identifies the sensor as requiring service. In response identifying the sensor as requiring service, controller 104 may set a diagnostic trouble code (DTC) and/or continue vehicle operation without using data from the degraded sensor.

After performing block 350, process 300 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network e.g., communications network 180, in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It should further be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. The adjectives “first.” “second.” and “third” are used throughout this document as identifiers and are not intended to signify importance, order, or quantity. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system comprising:
a heat exchanger having an inlet port and an outlet port;
a reservoir having an inlet port and an outlet port;
a conduit directly fluidly coupling the outlet port of the heat exchanger to the inlet port of the reservoir;
a manifold having an inlet port and a plurality of outlet ports, the inlet port fluidly coupled to the outlet port of the reservoir, the plurality of outlet ports including a first outlet port and a plurality of second outlet ports, the first outlet port being fluidly coupled to the inlet port of the heat exchanger;
a set of pumps at the second outlet ports of the manifold, the pumps being positioned to distribute fluid from the second outlet ports to a set of sensors;
a temperature sensor within the reservoir; and
a controller communicatively coupled to the temperature sensor, the controller programmed to actuate flow of cleaning fluid from the manifold to the heat exchanger responsive to an output signal from the temperature sensor.

2. The system of claim 1, wherein the controller is programmed to actuate flow of the cleaning fluid through the heat exchanger responsive to the temperature sensor indicating that the temperature of the cleaning fluid is below a first threshold value.

3. The system of claim 1, wherein the temperature sensor is positioned at a bottom portion of the reservoir.

4. The system of claim 1, wherein the temperature sensor is positioned within the reservoir proximate with the outlet port of the reservoir.

5. The system of claim 1, wherein the system is positioned in a vehicle, and wherein the heat exchanger comprises a fluid conduit integrated into a radiator structure of the vehicle.

6. The system of claim 1, wherein the system is positioned in a vehicle, and wherein the heat exchanger comprises a first fluid conduit integrated into a radiator structure of the vehicle, the first fluid conduit being proximate with a second fluid conduit of the radiator structure that is positioned to carry coolant from a propulsion component of the vehicle.

7. The system of claim 1, wherein the controller is additionally programmed to deactivate fluid flow from the manifold to the heat exchanger responsive to the output signal from the temperature sensor indicating that the temperature of the cleaning fluid is above a second threshold value.

8. The system of claim 1, wherein the system is positioned in a vehicle, and wherein the number of pumps of the set of pumps of the manifold corresponds to the number of sensors of the set of sensors.

9. The system of claim 1, wherein the manifold further comprises a check valve at each pump of the set of pumps.

10. The system of claim 1, wherein the controller is additionally programmed to actuate cleaning fluid flow from the manifold to the heat exchanger responsive to the output signal from the temperature sensor indicating a temperature that is between a first threshold value and a second threshold value.

11. The system of claim 1, wherein the controller is additionally programmed to maintain the temperature of the cleaning fluid between a first threshold and a second threshold at all times while a vehicle including the system is being operated.

12. The system of claim 1, wherein the controller is additionally programmed to intermittently initiate fluid flow from the reservoir to a sensor of the set of sensors based on an air temperature of an environment external to the system.

13. The system of claim 1, wherein the controller is additionally programmed to periodically initiate fluid flow to a sensor of the set of sensors at an increased frequency based on a decreased air temperature of an environment external to the system.

14. The system of claim 1, wherein the controller is additionally programmed to actuate cleaning fluid flow from the manifold to the heat exchanger responsive to the output signal from the temperature sensor indicating a temperature that is between a first threshold value and a second threshold value, the first threshold value and the second threshold value being selected to exclude degradation of a hydrophobic coating of a sensor surface.

15. The system of claim 1, further comprising a circulation pump positioned at the inlet port of the manifold.

16. The system of claim 1, further comprising a circulation pump positioned at the inlet port of the manifold, the circulation pump circulating the cleaning fluid through the heat exchanger and through the reservoir.

17. The system of claim 1, further comprising a circulation pump positioned at the inlet port of the manifold, the circulation pump configured to circulate the cleaning fluid through the heat exchanger and through the reservoir until the temperature sensor outputs a signal indicating that the temperature of the cleaning fluid has reached or exceeded a first threshold value.

18. The system of claim 1, further comprising a circulation pump, positioned at the inlet port of the manifold at a first end portion of the manifold.

19. The system of claim 1, further comprising a circulation pump, positioned at the inlet port of the manifold at a first end portion of the manifold, wherein the first outlet port of the manifold is positioned at a second end portion of the manifold that is opposite the first end portion.

20. The system of claim 1, wherein the inlet port to the reservoir is positioned at a location opposite the first outlet port of the reservoir.
